(19) United States
(12) Patent Application Publication
(10) Pub. No.: US 2024/0159510 A1
(43) Pub. Date: May 16, 2024

(54) ROTATIONAL ANGLE MEASUREMENT APPARATUS

(71) Applicant: DENSO CORPORATION, Kariya-city (JP)

(72) Inventors: Ryoya HASHIZUME, Nisshin-city (JP); Harumi HORIHATA, Kariya-city (JP)

(73) Assignee: DENSO CORPORATION, Kariya-city (JP)

(21) Appl. No.: 18/418,572

(22) Filed: Jan. 22, 2024

Related U.S. Application Data
(63) Continuation of application No. PCT/JP2022/025103, filed on Jun. 23, 2022.

(30) Foreign Application Priority Data
Jul. 21, 2021 (JP) 2021-120375

(51) Int. Cl. G01B 7/30; G01D 5/20

(52) U.S. Cl. CPC G01B 7/30; G01D 5/20

(57) ABSTRACT

A rotational angle measurement apparatus is applicable to a rotary electric machine that includes an outer rotor rotatable around a predetermined reference axis, and a stator disposed radially inside the outer rotor. The rotational angle measurement apparatus includes at least one measurement portion mounted to the outer rotor, and a measuring member located radially outside the stator to face the at least one measurement portion. The measuring member is configured to measure a position of the at least one measurement portion.

### REFERENCE TO RELATED APPLICATIONS

This application is a bypass continuation application of currently pending international application No. PCT/JP2022/025103 filed on Jun. 23, 2022 designating the United States of America, the entire disclosure of which is incorporated herein by reference, the international application being based on and claiming the benefit of priority from Japanese Patent Application No. 2021-120375 filed on Jul. 21, 2021, the disclosure of which is incorporated in their entirety herein by reference.

### TECHNICAL FIELD

The present disclosure relates to rotational angle measurement apparatuses for detecting a rotational angle of a rotary electric machine.

### BACKGROUND OF THE INVENTION

An outer-rotor rotary electric machine, i.e., an outer-rotor motor, disclosed in Japanese Patent Application Publication No. 2019-75976 includes a stator, a rotary shaft disposed radially inside of the stator to be rotatable, an outer rotor disposed radially outside of the stator to be rotatable together with the rotary shaft. The outer-rotor motor additionally includes a measurement portion mounted to the rotary shaft, and a measuring member disposed to face the measurement portion and configured to measure the position of the measurement portion.

### SUMMARY

The configuration of the outer-rotor rotary electric machine disclosed in the patent publication in which the measurement portion is mounted to the rotary shaft requires the measuring member disposed in the vicinity of the rotary shaft. Most of such outer-rotor rotary electric machines may have lack of space radially inside thereof. For example, such an outer-rotor rotary electric machine may be used as an in-wheel motor disposed in a tire-wheel assembly. In such an outer-rotor rotary electric machine used as an in-wheel motor, a brake device and/or an inverter are installed in an inner hollow space defined radially inside the tire-wheel assembly, resulting in lack of space radially inside the rotary shaft around the outer-rotor rotary electric machine. This may therefore make it difficult to install such a measuring member in such an insufficient space radially inside the rotary shaft.

From this viewpoint, the present disclosure provides rotational angle measurement apparatuses to be applied for an outer-rotor rotary electric machine, each of which includes a more easily installed measuring member.

An example of a rotational angle measurement apparatus according to the present disclosure is applicable to a rotary electric machine that includes an outer rotor rotatable around a predetermined reference axis, and a stator disposed radially inside the outer rotor. The rotational angle measurement apparatus includes at least one measurement portion mounted to the outer rotor, and a measuring member located radially outside the stator to face the at least one measurement portion. The measuring member is configured to measure a position of the at least one measurement portion.

The at least one measurement portion is mounted to the outer rotor, and the measuring member is located radially outside the stator to face the at least one measurement portion. Even if there is lack of space radially inside the rotary electric machine, the above configuration of the rotational angle measurement apparatus enables the measuring member to be unaffected by the lack of space radially inside the rotary electric machine.

Accordingly, even if being applied to an outer-rotor rotary electric machine, the rotational angle measurement apparatus includes the more easily installed measuring member.

### BRIEF DESCRIPTION OF THE DRAWINGS

The above object, other objects, characteristics, and advantageous benefits of the present disclosure will become apparent from the following description with reference to the accompanying drawings in which:

FIG. 1 is a sectional elevational view illustrating a rotary electric machine and a rotational angle measurement apparatus according to the first embodiment;

FIG. 2 is a side view illustrating the rotary electric machine and the rotational angle measurement apparatus;

FIG. 3 is a partially cross-sectional perspective view illustrating the rotary electric machine and the rotational angle measurement apparatus;

FIG. 4 is an exploded perspective view schematically illustrating the rotational angle measurement apparatus;

FIG. 5 is a circuit diagram schematically illustrating any measuring circuit when a measurement portion is located at a first position;

FIG. 6 is a circuit diagram schematically illustrating any measuring circuit when a measurement portion is located at a second position;

FIG. 7 is a circuit diagram schematically illustrating any measuring circuit when a pair of adjacent measurement portions is located at a third position;

FIG. 8 is a circuit diagram schematically illustrating any measuring circuit when a measurement portion is located at a fourth position;

FIG. 9A is a graph illustrating a waveform of an exciting current;

FIG. 9B is a graph illustrating a waveform of a received voltage;

FIG. 10 is an exploded perspective view schematically illustrating a rotational angle measurement apparatus of the second embodiment;

FIG. 11 is an exploded perspective view schematically illustrating a rotational angle measurement apparatus of the third embodiment;

FIG. 12 is a partially cross-sectional perspective view illustrating a rotary electric machine and a rotational angle measurement apparatus of the fourth embodiment;

FIG. 13 is a perspective view illustrating a rotational angle measurement apparatus of the fifth embodiment; and

FIG. 14 is a partially cross-sectional perspective view illustrating a rotary electric machine and a rotational angle measurement apparatus of the sixth embodiment.

### DESCRIPTION OF EXEMPLARY EMBODIMENT

The following describes exemplary embodiments of the present disclosure with reference to accompanying drawings. The present disclosure is however not limited to the following exemplary embodiments, and therefore can be executed as being freely modified within the scope of the subject matter of the present disclosure.

### First Embodiment

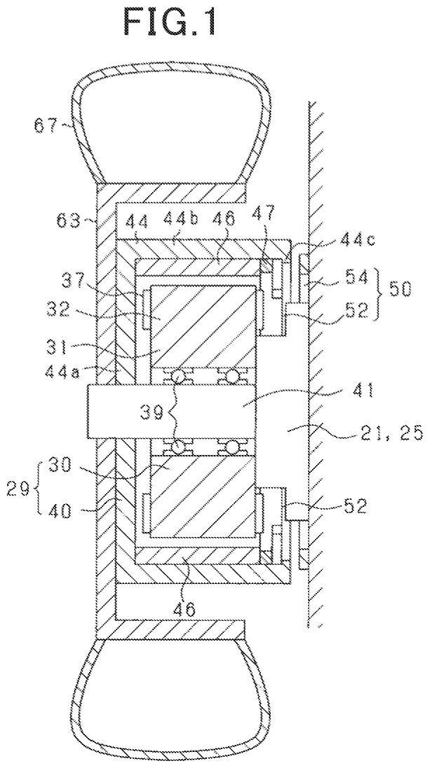

FIG. 1 is a sectional elevational view illustrating a rotary electric machine 29 and a rotational angle measurement apparatus 50 according to the first embodiment. The rotational angle measurement apparatus 50 is applied to the rotary electric machine 29. The rotary electric machine 29 is configured as an in-wheel motor, and disposed inside a tire-wheel assembly of an electric vehicle; the tire-wheel assembly is comprised of a wheel 63 and a tire 67. The rotary electric machine 29 has a predetermined reference axis that has opposing first and second axial directions. The rotary electric machine 29 includes an outer rotor 40 and a stator 30. The outer rotor 40 is configured to be rotatable about the predetermined reference axis together with the tire 67 and the wheel 63 of the tire-wheel assembly. The stator 30 is disposed radially inside of the outer rotor 40.

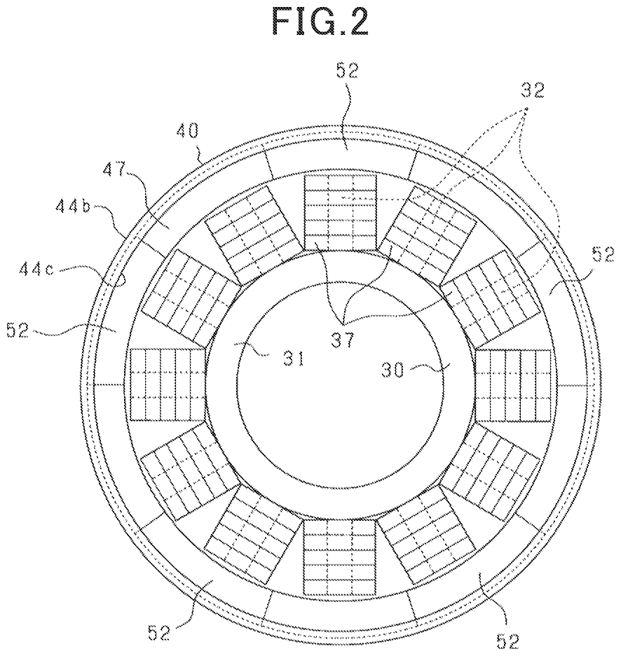

FIG. 2 is a side view illustrating the rotary electric machine 29. More specifically, FIG. 2 is a side view of the rotary electric machine 29 when the rotary electric machine 29 is viewed from the right side of FIG. 1 toward the left direction of FIG. 1.

The stator 30 includes a yoke, which will be referred to as a stator yoke, 31, teeth 32, and a three-phase coil, i.e., a three-phase coil assembly, 37.

The stator yoke 31 has a substantially circular-arc shape around the predetermined reference axis. The teeth 32 are arranged to respectively protrude from the stator yoke 31 radially outward from the stator yoke 31. The three-phase coil assembly 37 is wound around the teeth 32.

The outer rotor 40 includes, as illustrated in FIG. 1, bearings 39, a rotary shaft 41, a rotor body 44, a plurality of permanent magnets 46, and a spacer 47.

The rotary shaft 41 is disposed on the predetermined reference axis and located radially inside the stator yoke 31. The rotary shaft 41 is configured to be rotatable on the predetermined reference axis. The bearings 39 are each placed between the stator yoke 31 and the rotary shaft 41.

The rotor body 44 is mounted to the rotary shaft 41 to be rotatable together with the rotary shaft 41. The rotor body 44 is comprised of a tubular cylindrical rotor yoke 44b having first and second annular ends, and a bottom 44a fitted in the second annular end of the rotor yoke 44b, so that the second annular end of the rotor yoke 44b is closed. The bottom 44a of the rotor body 44 is arranged to join the rotor yoke 44b and the rotary shaft 41 to one another. The first annular end of the rotor yoke 44b defines an opening thereinside; the opening faces toward the first axial direction of the predetermined reference axis, i.e., the right direction in FIG. 1.

The permanent magnets 46 are mounted to the rotor body 44 to be rotatable together with the rotor body 44. Similarly, the spacer 47 is mounted to the rotor body 44 to be rotatable together with the rotor body 44.

An inverter 21 is disposed at the first axial direction of the predetermined reference axis. The inverter 21 is configured to supply three-phase alternating currents to the three-phase coil 37. Additionally, a brake pad 25 is disposed at the first axial direction of the predetermined reference axis. The brake pad 25 is capable of reducing rotation of the tire-wheel assembly as required. The rotor body 44 has an inner peripheral surface, and the stator 30 has an outer peripheral surface.

The inverter 21 and the brake pad 25 are disposed radially inside the inner peripheral surface of the rotor body 44. For more detail, the inverter 21 and the brake pad 25 are disposed radially inside the outer peripheral surface of the stator 30.

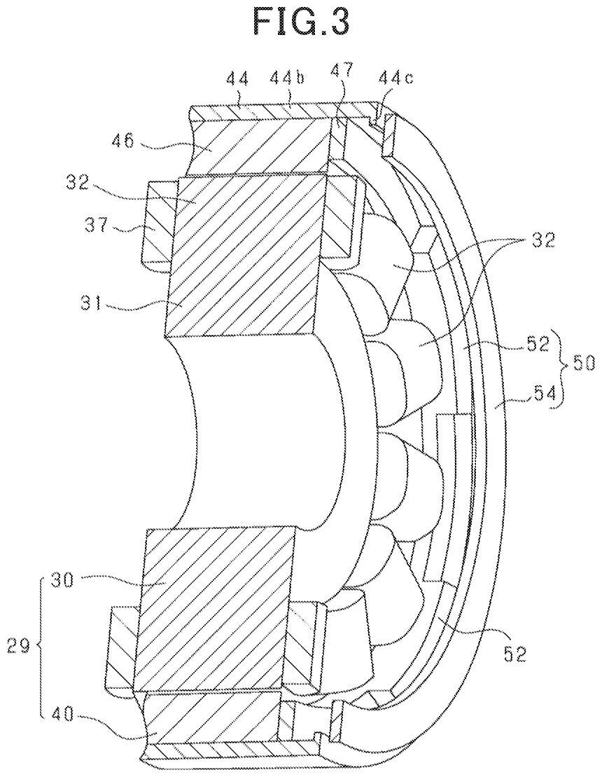

FIG. 3 is a partially cross-sectional perspective view illustrating the rotary electric machine 29 and the rotational angle measurement apparatus 50. The outer rotor 40 is configured as a surface permanent-magnet rotor. The rotor body 44 has a radially inner peripheral surface, and the permanent magnets 46 are fixedly mounted on the radially inner peripheral surface of the rotor body 44. The first annular end of the rotor yoke 44b has a radially inner surface, and a flange 44c is formed on the radially inner surface of the first annular end of the rotor yoke 44b to protrude radially inward from the radially inner surface. The spacer 47 has a ring shape around the predetermined reference axis, and is composed of a non-magnetic conductive member. The spacer 47 is interposed between the flange 44c and the permanent magnets 46. The spacer 47, which is arranged to be aligned with the permanent magnets 46 in the direction of the predetermined reference axis, serves to position the permanent magnets 46 with respect to the rotor body 44 in the direction of the predetermined reference axis.

The rotational angle measurement apparatus 50 includes, as measurement target, measurement portions 52 mounted to the spacer 47 at regular intervals around the predetermined reference axis. The rotational angle measurement apparatus 50 also includes a measuring member 54 located to face the measurement portions 52. The measurement portions 52 are formed to be integral with the spacer 47, so that each of the measurement portions 52 is a non-magnetic conductive portion. The spacer 47 has opposing first and second end surfaces in the direction of the predetermined reference axis; the second end surface is closer to the permanent magnets 46 than the first end surface is. Each measurement portion 52 is formed on the first end surface of the spacer 47 to convexly protrude from the first end surface of the spacer 47 toward the first axial direction of the predetermined reference axis.

For more detail, each measurement portion 52 is engaged with the flange 44c in the direction of the predetermined reference axis. This results in movement of the spacer 47 in the first axial direction of the predetermined reference axis being restricted. The second end surface of the spacer 47, which is closer to the permanent magnets 46 than the first end surface is, are located to abut onto the permanent magnets 46, so that the permanent magnets 46 are also engaged with the flange 44c through the spacer 47. This results in movement of the permanent magnets 46 in the first axial direction of the predetermined reference axis being restricted. Each permanent magnet 46 has a radially inner surface, and each measurement portion 52 has a radially inner surface. The radially inner surface of each measurement portion 52 is located to be farther away from the predetermined reference axis than the radially inner surface of each permanent magnet 46 is.

The measurement portions 52 are, as illustrated in FIG. 2, arranged at regular intervals around the predetermined reference axis. Each measurement portion 52 has a predetermined radial thickness, and the flange 44c has a predetermined radial thickness. The predetermined radial thickness of each measurement portion 52 is greater than the predetermined radial thickness of the flange 44c, to that each measurement portion 52 protrudes radially inward, resulting in each measurement portion 52 being exposed toward the first axial direction of the predetermined reference axis.

The measuring member 54 is, as illustrated in FIG. 3, comprised of an annular member around the predetermined reference axis, and is fixedly mounted to, for example, the body of the electric vehicle while facing the spacer 47. The measuring member 54 is located radially outside the stator 30. The measuring member 54 is also arranged to face the spacer 47 in the direction of the predetermined reference axis. That is, the measuring member 54 is located across the spacer 47 from the permanent magnets 46 while facing the exposed portion of each measurement portion 52 in the direction of the predetermined reference axis. The measuring member 54 has a predetermined center axis, and is arranged such that the center axis of the measuring member 54 is coaxial with the predetermined reference axis. Each of the rotor body 44 and the measuring member 54 has a predetermined outer diameter, and the outer diameter of the measuring member 54 is slightly smaller than the outer diameter of the rotor body 44. Each of the spacer 47 and the measuring member 54 has a predetermined inner diameter, and the inner diameter of the measuring member 54 is substantially identical to the inner diameter of the spacer 47.

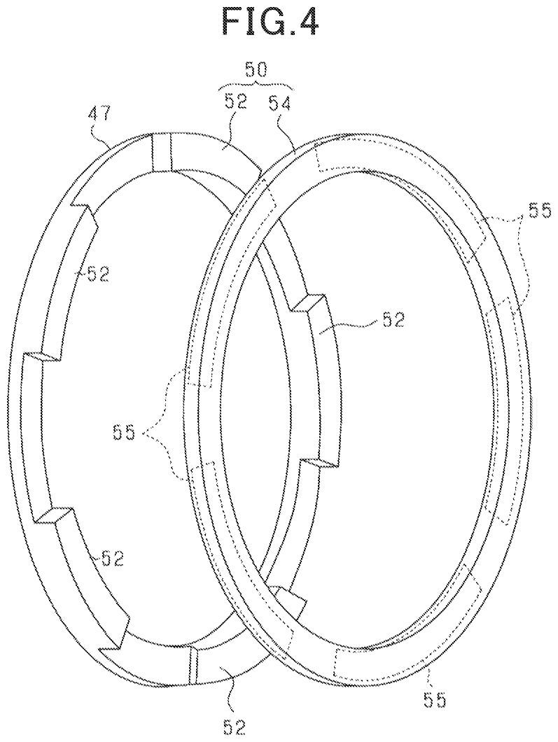

FIG. 4 is an exploded perspective view schematically illustrating the rotational angle measurement apparatus 50. Each of the spacer 47 and the measuring member 54 has, as described above, an annular shape, and each measurement portion 52 is formed on the annular spacer 47 to convexly protrude therefrom. The measuring member 54 is designed as an inductive sensor, and includes plural measuring circuits 55 located at substantially regular intervals around the predetermined reference axis.

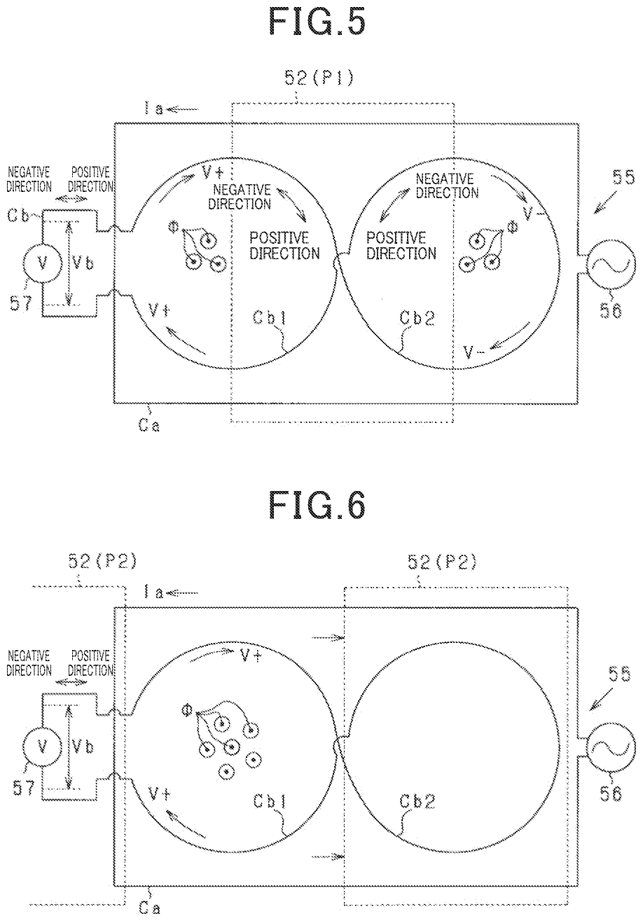

FIG. 5 is a circuit diagram schematically illustrating any of the measuring circuits 55 arranged around the predetermined reference axis. Note that each measuring circuit 55 is configured as a modular case, and the modular case of each measuring circuit 55 actually has, as illustrated in FIG. 4, a circular-arc shape along the annular measuring member 54. At that time, for the sake of improving the visibility of the measuring circuit 55, FIG. 5 illustrates the measuring circuit 55 whose modular case has a rectangular shape. Each measuring circuit 55 includes an exciting circuit Ca and a receiving circuit Cb.

The following defines that “plan view” of any object means a view seen from the first axial direction of the predetermined reference axis.

The receiving circuit Cb has an infinity symbol shape (cc) in plan view. Hereinafter, for example, the receiving circuit Cb includes a circular first receiving circuit Cb1 located at the left half thereof in plan view, and a circular second receiving circuit Cb2 located at the right half thereof in plan view. In the circular first receiving circuit Cb1, the clockwise rotation, i.e., the right-hand turning, is defined as a positive direction, and the counterclockwise rotation, i.e., the left-hand turning, is defined as a negative direction. Because the receiving circuit Cb has the infinity symbol shape (cc), in the circular second receiving circuit Cb2, the counterclockwise rotation, i.e., the left-hand turning, is defined as a positive direction, and the clockwise rotation, i.e., the right-hand turning, is defined as a negative direction.

A voltage sensor 57 is connected to the receiving circuit Cb. The voltage sensor 57 is configured to measure a voltage induced in the receiving circuit Cb.

The exciting circuit Ca has an annular shape surrounding the twisted-loop receiving circuit Cb in plan view. To the exciting circuit Ca, an alternating-current (AC) voltage source 56 is connected for causing an exciting alternating current Ia to flow in the exciting circuit Ca.

The following describes a first case where a value of a rotational angle of the outer rotor 40 causes any measurement portion 52 to be located at a first position P1 at which the measurement portion 52 overlaps the right half of the first receiving circuit Cb1 and the left half of the second receiving circuit Cb2 in plan view (see FIG. 5).

An increase in the exciting current Ia in the counterclockwise direction (left-hand direction) in plan view causes magnetic flux Φ directed toward the near side from FIG. 5 to increase inside the exciting circuit Ca. This results in an eddy current being created to flow in the measurement portion 52 in the direction in which an increase in the magnetic flux Φ is suppressed. This suppresses an increase in the magnetic flux Φ in the right half of the first receiving circuit Cb1 and the left half of the second receiving circuit Cb2 that the measurement portion 52 overlaps in plan view.

In contrast, the increase in the magnetic flux Φ in each of the left half of the first receiving circuit Cb1 and the right half of the second receiving circuit Cb2 that the measurement portion 52 does not overlap in plan view, which is not suppressed by the eddy current, induces a voltage in the clockwise direction, i.e., the right-hand direction. As described above, the clockwise direction in the first receiving circuit Cb1 is the positive direction, and the clockwise direction in the second receiving circuit Cb2 is the negative direction. For this reason, a positive voltage V+ is induced in the first receiving circuit Cb1 whereas a negative voltage V− is induced in the second receiving circuit Cb2, resulting in a received voltage Vb becoming substantially zero.

Next, the following describes a second case where a value of the rotational angle of the outer rotor 40 causes any measurement portion 52 to be located at a second position P2 at which the measurement portion 52 overlaps the second receiving circuit Cb2 without overlapping the first receiving circuit Cb1 in plan view (see FIG. 6).

An increase in the exciting current Ia in the counterclockwise direction (left-hand direction) in plan view causes an increase in magnetic flux Φ directed toward the near side from FIG. 6 in the first receiving circuit Cb1 without being suppressed whereas an increase in the magnetic flux Φ is suppressed in the second receiving circuit Cb2. This results in (i) a positive voltage V+ being induced in the first receiving circuit Cb1 without being suppressed and (ii) an inducing of a negative voltage V− being suppressed in the second receiving circuit Cb2, resulting in the received voltage Vb becoming positive.

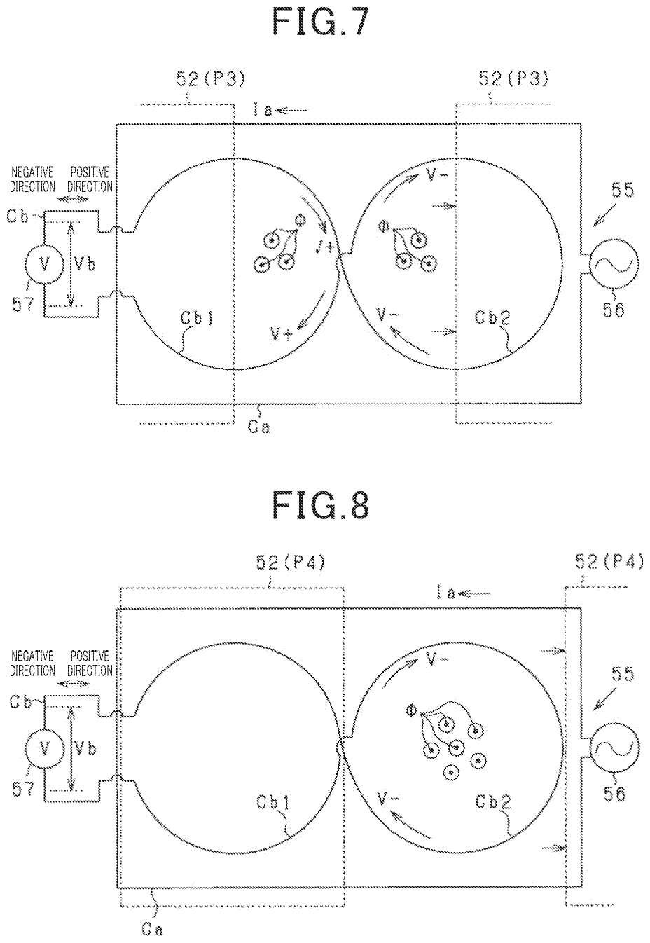

Next, the following describes a third case where a value of the rotational angle of the outer rotor 40 causes any pair of adjacent measurement portions 52 to be located at a third position P3 at which one of the paired measurement portions 52 overlaps the left half of the first receiving circuit Cb1 and the other of the paired measurement portions 52 overlaps the right half of the second receiving circuit Cb2 in plan view (see FIG. 7).

An increase in the exciting current Ia in the counterclockwise direction (left-hand direction) in plan view causes an increase in magnetic flux Φ directed toward the near side from FIG. 7 in each of the right half of the first receiving circuit Cb1 and the left half of the second receiving circuit Cb2 whereas an increase in the magnetic flux Φ is suppressed in each of the left half of the first receiving circuit Cb1 and the right half of the second receiving circuit. The increase in the magnetic flux Φ in each of the right half of the first receiving circuit Cb1 and the left half of the second receiving circuit Cb2 induces a voltage in the clockwise direction, i.e., the right-hand direction in the corresponding one of the right half of the first receiving circuit Cb1 and the left half of the second receiving circuit Cb2. As described above, the clockwise direction in the first receiving circuit Cb1 is the positive direction, and the clockwise direction in the second receiving circuit Cb2 is the negative direction. For this reason, a positive voltage V+ is induced in the first receiving circuit Cb1 whereas a negative voltage V− is induced in the second receiving circuit Cb2, resulting in a received voltage Vb becoming substantially zero.

Next, the following describes a fourth case where a value of the rotational angle of the outer rotor 40 causes any measurement portion 52 to be located at a fourth position P4 at which the measurement portion 52 does not overlap the first and second receiving circuits Cb1 and Cb2 in plan view (see FIG. 8).

An increase in the exciting current Ia in the counterclockwise direction (left-hand direction) in plan view causes an increase in magnetic flux Φ directed toward the near side from FIG. 8 in the second receiving circuit Cb2 without being suppressed whereas an increase in the magnetic flux Φ is suppressed in the first receiving circuit Cb1. This results in (i) an inducing of a positive voltage V+ being suppressed in the first receiving circuit Cb1 and a negative voltage V− being induced in the second receiving circuit Cb1 without being suppressed, resulting in the received voltage Vb becoming negative.

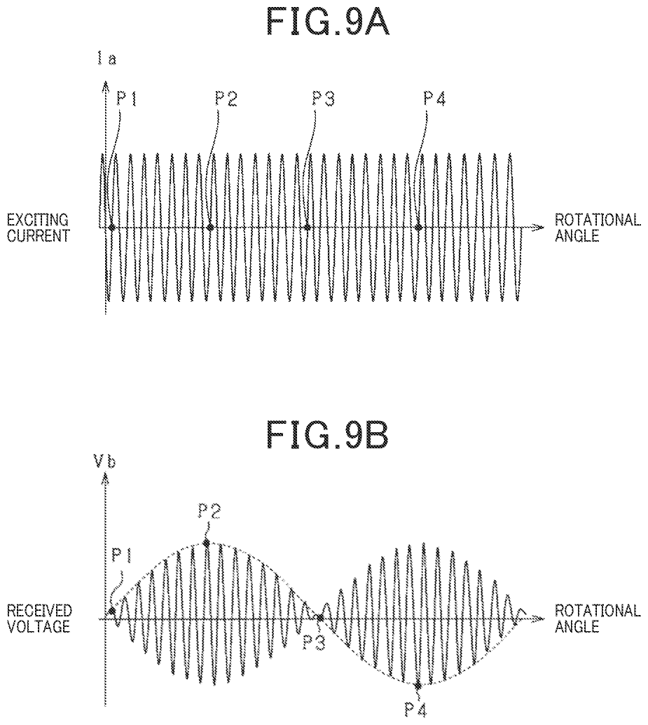

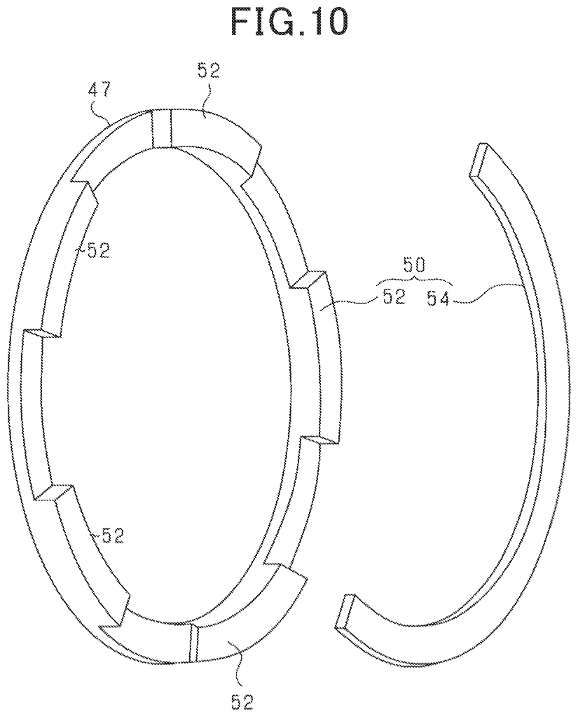

FIG. 9A is a graph illustrating a waveform of the exciting current Ia, and FIG. 9B is a graph illustrating a waveform of the received voltage Vb.

As described above, when each measurement portion 52 is located at the first position P1, the received voltage Vb becomes substantially zero in response to an increase in the exciting current Ia.

When each measurement portion 52 is located at the second position P2, the received voltage Vb becomes positive in response to an increase in the exciting current Ia.

When each measurement portion 52 is located at the third position P3, the received voltage Vb becomes substantially zero in response to an increase in the exciting current Ia.

When each measurement portion 52 is located at the fourth position P4, the received voltage Vb becomes negative in response to an increase in the exciting current Ia.

Accordingly, the rotational angle measurement apparatus 50 is configured to measure the rotational angle of the outer rotor 40 in accordance with the received voltage Vb changing set forth above.

The following describes advantageous benefits that can be achieved by the rotational angle measurement apparatus 50 according to the first embodiment.

The measurement portions 52 of the rotational angle measurement apparatus 50 are mounted to the outer rotor 40, and the measuring member 54 is located radially outside the stator 30 to face the measurement portions 52. Even if there is lack of space radially inside the rotary electric machine 29 due to installation of, for example, the inverter 21 and the brake pad 25, the above configuration of the rotational angle measurement apparatus 50 enables the measuring member 54 to have no interference with, for example, the inverter 21 and the brake pad 25.

The measurement portions 52 of the first embodiment are formed to be integral with the spacer 47. This reduces the number of components of the rotational angle measurement apparatus 50 as compared with a comparative-example rotational angle measurement apparatus whose measurement portions 52 are provided as independent separate members from the spacer 47. Additionally, only mounting the spacer 47 to the rotor body 44 accurately enables the measurement portions 52 to be accurately installed at the respective designed positions. This enables the installed measurement portions 52 to have no or very small margin of error relative to their designed positions, making it possible to improve the measurement accuracy of the rotational angle measurement apparatus 50. Moreover, the configuration of the spacer 47 integrated with the measurement portions 52 saves space in one of the first and second axial directions of the predetermined reference axis as compared with a comparative-example rotational angle measurement apparatus whose measurement portions 52 are provided as independent separate members from the spacer 47.

The spacer 47 is interposed between the flange 44c and the permanent magnets 46, each measurement portion 52 is formed on the first end surface of the spacer 47, and the measuring member 54 is located across the spacer 47 from the permanent magnets 46; the first end surface of the spacer 47 is opposite to the second end surface thereof that is closer to the permanent magnets 46 than the first end surface is.

This configuration enables (i) the measurement portions 52 to be simply integrated with the spacer 47, and (ii) the measuring member 54 to be simply disposed radially outside the stator 30.

The radially inner surface of each measurement portion 52 is located to be farther away from the predetermined reference axis than the radially inner surface of each permanent magnet 46 is.

This configuration reduces an influence of a magnetic field created by the three-phase coil 37 on the measurement portions 52 as compared with a comparative-example rotational angle measurement apparatus whose radially inner surface of each measurement portion 52 is located to be flush with the radially inner surface of each permanent magnet 46. This therefore makes it possible to improve the measurement accuracy of the rotational angle measurement apparatus 50.

The measurement portions 52 are arranged at regular intervals around the predetermined reference axis. This enables the spacer 47 to have a better balance in mass, and the outer rotor 40 to have a better balance in mass.

Additionally, the measuring member 54 has an annular shape around the predetermined reference axis with a better balance around the predetermined reference axis, making it possible to improve the measurement accuracy of the rotational angle measurement apparatus 50.

The outer rotor 40 is configured as a surface permanent-magnet rotor, and the permanent magnets 46 are exposed on the radially inner peripheral surface of the outer rotor 40. This configuration results in an increase in an effective amount of magnetic flux and a decrease in torque ripple.

### Second Embodiment

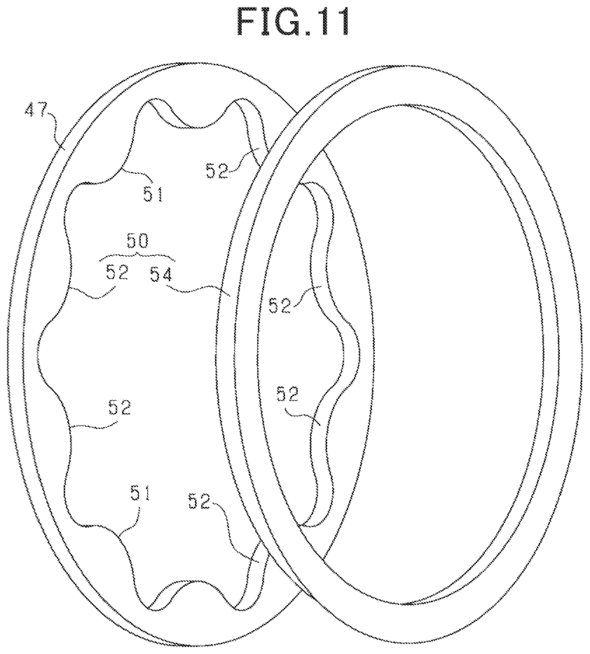

The following describes the second embodiments of the present disclosure with reference to FIG. 10. In the subsequent embodiments and the first embodiment, identical or similar reference characters are applied to identical or similar components or parts.

The following mainly describes different points of each of the subsequent embodiments from the first embodiment, and appropriately omits descriptions of the remaining points of each of the subsequent embodiments, which are similar to those of the first embodiment.

FIG. 10 is an exploded perspective view schematically illustrating a rotational angle measurement apparatus 50 of the second embodiment.

A measuring member 54 of the second embodiment has a semicircular shape around the predetermined reference axis. This saves space required to install the measuring member 54 of the second embodiment as compared with the first embodiment using the annular measuring member 54.

### Third Embodiment

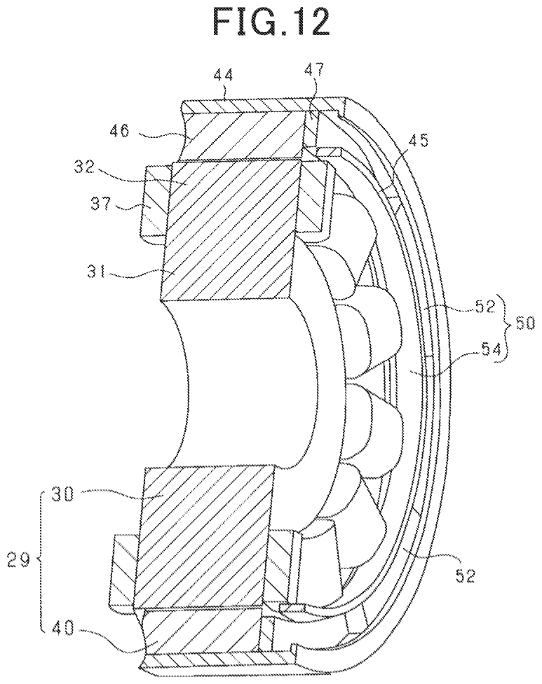

FIG. 11 is an exploded perspective view schematically illustrating a rotational angle measurement apparatus 50 of the third embodiment.

The spacer ring 47 has a radially inner peripheral surface.

Measurement portions 52 of the third embodiment are formed on the radially inner peripheral surface of the spacer 47 to protrude radially inward from the radially inner peripheral surface of the spacer 47 such that the whole of the measurement portions 52 have a wavy shape. A measuring member 54 of the third embodiment is located to face the measurement portions 52 in the first axial direction of the predetermined reference axis.

This configuration of the third embodiment is effective in a case where it is difficult to form convex measurement portions 52 on the spacer 47.

### Fourth Embodiment

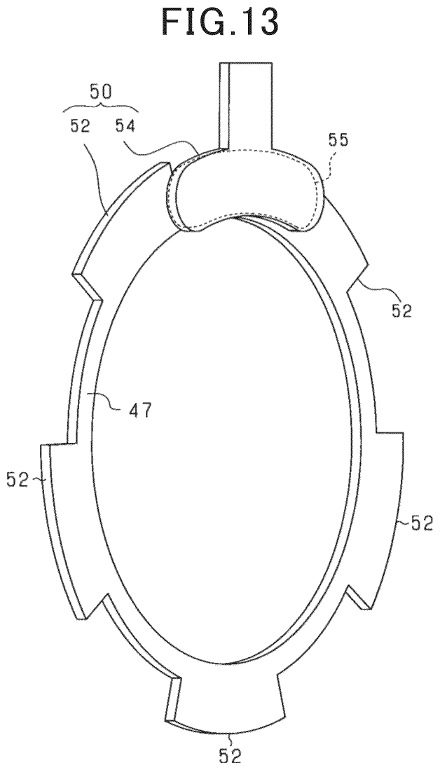

FIG. 12 is a partially cross-sectional perspective view illustrating a rotary electric machine 29 and a rotational angle measurement apparatus 50 of the fourth embodiment.

A measuring member 54 of the fourth embodiment is located radially inside the spacer 47. More specifically, the measuring member 54 of the fourth embodiment is located radially inside the measurement portions 52, which protrude toward the first axial direction of the predetermined reference axis, to face the measurement portions 52.

The measuring member 54 of the fourth embodiment is located radially inside the spacer 47, making it possible to save space in the direction of the predetermined reference axis as compared with a case where the measuring member 54 is located in the first axial direction of the predetermined reference axis.

### Fifth Embodiment

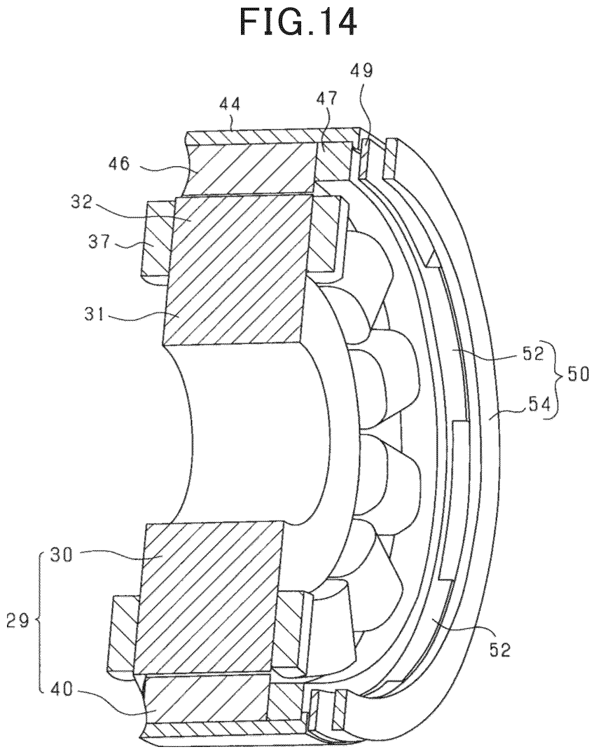

FIG. 13 is a perspective view illustrating a rotational angle measurement apparatus 50 of the fifth embodiment.

The spacer ring 47 has a radially outer peripheral surface.

Measurement portions 52 of the fifth embodiment are formed on the radially outer peripheral surface of the spacer 47 to convexly protrude radially outward from the radially outer peripheral surface of the spacer 47. A measuring member 54 of the fifth embodiment has a substantially circular-arc shape, and is disposed at the first axial direction of the predetermined reference axis to face the measurement portions 52.

The measurement portions 52 of the fifth embodiment, which are formed on the radially outer peripheral surface of the spacer 47 to convexly protrude radially outward from the radially outer peripheral surface of the spacer 47, makes it possible to save space in the direction of the predetermined reference axis as compared with a case where the measurement portions 52 is disposed to protrude toward the first axial direction of the predetermined reference axis. Additionally, the measuring member 54 of the fifth embodiment, which has a substantially circular-arc shape, makes it possible to save space required to install the measuring member 54 as compared with a case where the measuring member 54 has an annular shape.

### Sixth Embodiment

FIG. 14 is a partially cross-sectional perspective view illustrating a rotary electric machine 29 and a rotational angle measurement apparatus 50 of the sixth embodiment.

Measurement portions 52 of the sixth embodiment are separated from the spacer 47, and the spacer 47 has a constant thickness in the direction of the predetermined reference axis.

The rotor yoke 44b has an outer surface at the first axial direction of the predetermined reference axis, more specifically, has an outer surface of the first annular end of the rotor yoke 44b. A non-magnetic conducive ring member 49 is mounted on the outer surface of the first annular end of the rotor yoke 44b. The ring member 49 has opposing first and second end surfaces in the respective first and second axial directions of the predetermined reference axis. Non-magnetic conductive measurement portions 52 are formed on the first end surface of the ring member 49 to convexly protrude toward the first axial direction of the predetermined reference axis.

The above configuration of the sixth embodiment enables the measurement portions 52 to be separated from the spacer 47. The above configuration of the sixth embodiment is therefore effective in cases where it is difficult to form the non-magnetic conductive measurement portions 52 on the spacer 47, such as a case where it is difficult to use a non-magnetic conductive member as the spacer 47.

### MODIFICATIONS

The above-mentioned embodiments can be for example modified as follows:

The spacer 47 of each of the first to sixth embodiments is provided as a separate member from the rotor body 44 (see, for example, FIG. 3). In place of this configuration, the spacer 47 can be formed to be integral with the rotor body 44, which serves as a positioning member.

The measurement portions 52 of each of the first to sixth embodiments is formed to be integral with the spacer 47 (see, for example, FIG. 3). In place of this configuration, the measurement portions 52 can be provided as separate members from the spacer 47, and can be mounted to the spacer 47.

The measurement portions 52 of the third embodiment illustrated in FIG. 11 protrude radially inward from the radially inner peripheral surface of the spacer 47 such that the whole of the measurement portions 52 have a wavy shape. In place of this configuration, the measurement portions 52 can protrude toward the first axial direction of the predetermined reference axis from the first end surface of the spacer 47.

The measurement portions 52 of the fourth embodiment illustrated in FIG. 12 protrude toward the first axial direction of the predetermined reference axis from the first end surface of the spacer 47. In place of this configuration, the measurement portions 52 can protrude radially inward from the radially inner peripheral surface of the spacer 47.

Additionally, the measuring member 54 of the fourth embodiment is located radially inside the measurement portions 52 to face the measurement portions 52. In place of this configuration, the measuring member 54 can be located radially outside the measurement portions 52 to face the measurement portions 52. In this modification, the rotor yoke 44b need be composed of a non-magnetic and non-conductive member that generates no eddy current.

The measurement portions 52 of the fifth embodiment illustrated in FIG. 13 protrude radially outward from the radially outer peripheral surface of the spacer 47. In place of this configuration, the measurement portions 52 can protrude radially inward from the radially inner peripheral surface of the spacer 47.

The spacer 47 and the measurement portions 52 of each of the first to sixth embodiments are, as illustrated in for example FIG. 1, arranged to be closer to the first axial direction of the predetermined reference axis, in other words, arranged to be closer to the opening of the first annular end of the rotor yoke 44b of the outer rotor 40. In place of this configuration, the spacer 47 and the measurement portions 52 can be arranged to be closer to the second axial direction of the predetermined reference axis, in other words, arranged to be closer to the bottom 44a of the outer rotor 40, while facing the measuring member 52.

One or more parts of any embodiment described above can be freely combined with one or more parts of another embodiment except for the combination(s) are principally impossible.

While the illustrative embodiments of the present disclosure have been described herein, the present disclosure is not limited to the embodiments and their configurations described herein, but includes any and all modifications and/or alternations as long as they are within a range of equivalency of the present disclosure. Additionally, (i) various combinations and embodiments and (ii) modified combinations and embodiments, which can be formed by adding one or more elements to the various combinations and embodiments are within the scope and technical idea of the present disclosure.

1. A rotational angle measurement apparatus applicable to a rotary electric machine that includes an outer rotor rotatable around a predetermined reference axis, and a stator disposed radially inside the outer rotor, the rotational angle measurement apparatus comprising:
at least one measurement portion mounted to the outer rotor; and
a measuring member located radially outside the stator to face the at least one measurement portion, the measuring member being configured to measure a position of the at least one measurement portion.

2. The rotational angle measurement apparatus according to claim 1, wherein:
the outer rotor comprises:
a rotor body provided to be rotatable around the predetermined reference axis;
at least one permanent magnet mounted to the rotor body; and
a positioning member located to face the at least one permanent magnet in a direction of the predetermined reference axis and configured to position the at least one permanent magnet with respect to the rotor body in the direction of the predetermined reference axis.

3. The rotational angle measurement apparatus according to claim 2, wherein:
the positioning member comprises a spacer as an independent separate member from the rotor body; and
the at least one measurement portion is formed to be integral with the spacer.

4. The rotational angle measurement apparatus according to claim 3, wherein:
the rotor body has a tubular cylindrical shape, a radially inner peripheral surface, first and second annular ends, and a bottom fitted in the second annular end, the first annular end of the rotor body defining an opening thereinside;
the at least one permanent magnet is fixedly mounted to the radially inner peripheral surface of the rotor body;
a flange is formed on the radially inner surface of the first annular end of the rotor body; and
the spacer is interposed between the flange and the at least one permanent magnet.

5. The rotational angle measurement apparatus according to claim 4, wherein:
the spacer has opposing first and second end surfaces in the direction of the predetermined reference axis, the second end surface being closer to the at least one permanent magnet than the first end surface is;
the at least one measurement portion is formed on the first end surface of the spacer; and
the measuring member is located across the spacer from the at least one permanent magnet in the direction of the predetermined reference axis.

6. The rotational angle measurement apparatus according to claim 4, wherein:
the measuring member is located radially inside the spacer.

7. The rotational angle measurement apparatus according to claim 2, wherein:
the positioning member is formed to be integrated with the rotor body.

8. The rotational angle measurement apparatus according to claim 2, wherein:
the at least one measurement portion is provided as an independent separate member from the positioning member; and
the at least one measurement portion is mounted to the positioning member.

9. The rotational angle measurement apparatus according to claim 2, wherein:
each of the at least one measurement portion and the at least one permanent magnet has a radially inner surface; and
the radially inner surface of the at least one measurement portion is located radially outside the radially inner surface of the at least one permanent magnet.

10. The rotational angle measurement apparatus according to claim 1, wherein:
the measuring member comprises an inductive sensor.

11. The rotational angle measurement apparatus according to claim 1, wherein:
the outer rotor comprises a rotor yoke provided to be rotatable around the predetermined reference axis; and
the measuring member is located radially inside the rotor yoke.
